(19) United States
(12) Patent Application Publication
(10) Pub. No.: US 2015/0079279 A1
(43) Pub. Date: Mar. 19, 2015

(54) METHOD FOR MANUFACTURING COLOR FILTER

(71) Applicant: Shenzhen China Star Optoelectronics Technology Co. Ltd., Shenzhen (CN)

(72) Inventor: Hsiao-hsien Chen, Shenzhen (CN)

(21) Appl. No.: 13/703,352

(22) PCT Filed: Jun. 8, 2012
(86) PCT No.: PCT/CN12/76668

§ 371 Date: Dec. 11, 2012

(30) Foreign Application Priority Data
May 30, 2012 (CN) 201210173691.6

(51) Int. Cl. B05D 5/06; G02B 5/22; G02B 5/20

(52) U.S. Cl. CPC B05D 5/065; G02B 5/201; G02B 5/22
USPC 427/162

(57) ABSTRACT

The present invention provides a method for manufacturing a color filter. A black matrix layer is formed on a substrate, and the substrate includes a first area, a second area and a third area at that moment. Then, a first color resist layer, a second color resist layer and a third color resist layer are formed on the first area, the second area and the third area, respectively. Curing temperatures of the first color resist layer and the second color resist layer are less than a curing temperature of the third color resist layer, and the first color resist layer, the second color resist layer and the third color resist layer are completely cured after treatment of a third temperature.

### BACKGROUND OF THE INVENTION

1. Field of the Invention

The present invention relates to a field of liquid crystal display technology, and more particularly, to a method for manufacturing a color filter.

2. Description of the Prior Art

In a manufacturing process for a traditional color filter, a black matrix layer, a color resist layer R, a color resist layer Q, a color resist layer B, a transparent electrode layer (e.g., ITO) and spacers (e.g., PS) are generally coated in sequence on a glass substrate.

Specifically, a black material layer is first coated on a substrate, and then forming a black matrix (BM) layer by a first exposing process, a developing process and a curing process in sequence. A material layer R is coated on the substrate having the BM layer, and then forming a color resist layer R by a second exposing process, the developing process and the curing process in sequence. A material layer G is coated on the substrate having the color resist layer R, and then forming a color resist layer G by a third exposing process, the developing process and the curing process in sequence. A material layer B is coated on the substrate having the color resist layer G, and then forming a color resist layer B by a fourth exposing process, the developing process and the curing process in sequence. Final, the ITO and the PS are formed on the substrate having the color resist layer B.

A material selected in the manufacturing process for forming the BM layer, the color resist layer R, the color resist layer G, the color resist layer B and the PS is generally a photoresist material (e.g., an acrylic polymer) in the manufacturing process. Properties of the material are needed to be at 220 degrees Celsius (° C.) environment to completely achieve a crosslinking reaction (i.e., complete cure). Since the difference between a machine temperature and an actual temperature in the manufacturing process, the machine temperature tends to increase by about 10 degrees (e.g., 230 ° C.) to achieve the manufacturing process, so that the crosslinking rate reaches 100%, thereby improving chemical resistance and light resistance of the material.

An oven selected in performance of the manufacturing process is generally a multi-tray type oven in the prior art. The oven can only perform a continuous operation for pushing and pulling the tray. In such operation, whether the oven is in a normal production state or a standby state, it will continue to keep at 230° C. to dissipate the energy, thereby increasing production costs.

### SUMMARY OF THE INVENTION

The present invention is to provide a method for manufacturing a color filter, so as to solve the prior art problem which has high energy dissipation and high costs when manufacturing the color filter.

An object of the present invention is to provide the method for manufacturing the color filter, wherein the method includes the following steps of: providing a substrate, and forming a black matrix (BM) layer onto the substrate, the substrate having the BM layer including a first area, a second area and a third area; coating a first material layer onto the substrate having the BM layer; and then forming a first color resist layer onto the first area by an exposing process, a developing process and a curing process in sequence, the curing process being performed at a first temperature, after performance of the curing process at the first temperature, the first color resist layer being slightly cured;

coating a second material layer onto the substrate having the first color resist layer, and then forming a second color resist layer onto the second area by the exposing process, the developing process and the curing process in sequence, the curing process being performed at a second temperature, after performance of the curing process at the second temperature, the second color resist layer being slightly cured;
coating a third material layer onto the substrate having the second color resist layer, and then forming a third color resist layer onto the third area by the exposing process, the developing process and the curing process in sequence, the curing process being performed at a third temperature, when the first color resist layer, the second color resist layer and the third color resist layer being cured by the third temperature, a complete cure of the first color resist layer, the second color resist layer and the third color resist layer being achieved by cooperating a curing time of the third temperature, wherein the third temperature is between 220° C. and 240° C.; the first color resist layer, the second color resist layer and the third color resist layer constructing a colored color resist layer; and
forming a transparent conductive layer and spacers onto the colored color resist layer, wherein the first temperature and the second temperature are less than the third temperature; in the slight cure, shapes of the first color resist layer and the second color resist layer remain fixed for a preset time; in the complete cure, shapes of the first color resist layer, the second color resist layer and the third color resist layer continuously remain fixed.

In the method for manufacturing a color filter according to the present invention, the first temperature is between 150° C. and 200° C.

In the method for manufacturing a color filter according to the present invention, the second temperature is between 150° C. and 200° C.

In the method for manufacturing a color filter according to the present invention, the slight cure of the first color resist layer is achieved by cooperating an exposure energy, a developing time and a curing time of the first temperature in a process of curing the first color resist layer by the first temperature.

In the method for manufacturing a color filter according to the present invention, the slight cure of the second color resist layer is achieved by cooperating an exposure energy, a developing time and a curing time of the second temperature in a process of curing the second color resist layer by the second temperature.

In the method for manufacturing a color filter according to the present invention, the first color resist layer does not react with a solvent used in a process for forming the second color resist layer in the slight cure; and the solvent used in a process for forming the second color resist layer includes a solvent for the second material layer and a developing solution used in a process for forming the second color resist layer.

In the method for manufacturing a color filter according to the present invention, the first color resist layer and the second color resist layer does not react with a solvent used in a process for forming the third color resist layer in the slight cure; and

the solvent used in a process for forming the third color resist layer includes a solvent for the third material layer and a developing solution used in a process for forming the third color resist layer.

In the method for manufacturing a color filter according to the present invention, the shapes of the first color resist layer and the second color resist layer remain fixed for the preset time that specifically includes: a shape of the first color resist layer remaining fixed for a first preset time, the first preset time being a time lasting until curing the third color resist layer; and a shape of the second color resist layer remaining fixed for a second preset time, the second preset time being a time lasting until curing the third color resist layer.

Another object of the present invention is to provide the method for manufacturing the color filter, wherein the method includes the following steps of: providing a substrate, and forming a black matrix (BM) layer onto the substrate, the substrate having the BM layer including a first area, a second area and a third area;

coating a first material layer onto the substrate having the BM layer; and then forming a first color resist layer onto the first area by an exposing process, a developing process and a curing process in sequence, the curing process being performed at a first temperature, after performance of the curing process at the first temperature, the first color resist layer being slightly cured;
coating a second material layer onto the substrate having the first color resist layer, and then forming a second color resist layer onto the second area by the exposing process, the developing process and the curing process in sequence, the curing process being performed at a second temperature, after performance of the curing process at the second temperature, the second color resist layer being slightly cured;
coating a third material layer onto the substrate having the second color resist layer, and then forming a third color resist layer onto the third area by the exposing process, the developing process and the curing process in sequence, the curing process being performed at a third temperature, after performance of the curing process at the third temperature, the first color resist layer, the second color resist layer and the third color resist layer being completely cured; the first color resist layer, the second color resist layer and the third color resist layer constructing a colored color resist layer; and
forming a transparent conductive layer and spacers onto the colored color resist layer, wherein the first temperature and the second temperature are less than the third temperature; in the slight cure, shapes of the first color resist layer and the second color resist layer remain fixed for a preset time; in the complete cure, shapes of the first color resist layer, the second color resist layer and the third color resist layer continuously remain fixed.

In one exemplary embodiment of the present invention, the first temperature is between 150° C. and 200° C.

In one exemplary embodiment of the present invention, the second temperature is between 150° C. and 200° C.

In one exemplary embodiment of the present invention, the third temperature is between 220° C. and 240° C.

In one exemplary embodiment of the present invention, the slight cure of the first color resist layer is achieved by cooperating an exposure energy, a developing time and a curing time of the first temperature in a process of curing the first color resist layer by the first temperature.

In one exemplary embodiment of the present invention, the slight cure of the second color resist layer is achieved by cooperating an exposure energy, a developing time and a curing time of the second temperature in a process of curing the second color resist layer by the second temperature.

In one exemplary embodiment of the present invention, the complete cure of the first color resist layer, the second color resist layer and the third color resist layer is achieved by cooperating a curing time of the third temperature in a process of curing the first color resist layer, the second color resist layer and the third color resist layer by the third temperature.

In one exemplary embodiment of the present invention, the first color resist layer does not react with a solvent used in a process for forming the second color resist layer in the slight cure; and

the solvent used in a process for forming the second color resist layer includes a solvent for the second material layer and a developing solution used in a process for forming the second color resist layer.

In one exemplary embodiment of the present invention, the first color resist layer and the second color resist layer does not react with a solvent used in a process for forming the third color resist layer in the slight cure; and

the solvent used in a process for forming the third color resist layer includes a solvent for the third material layer and a developing solution used in a process for forming the third color resist layer.

In one exemplary embodiment of the present invention, the shapes of the first color resist layer and the second color resist layer remain fixed for the preset time that specifically includes:

a shape of the first color resist layer remaining fixed for a first preset time, the first preset time being a time lasting until curing the third color resist layer; and
a shape of the second color resist layer remaining fixed for a second preset time, the second preset time being a time lasting until curing the third color resist layer.

In a process for forming the first color resist layer and the second color resist layer according to the present invention, the first temperature and the second temperature that have a lower temperature than that of the third temperature (e.g., 230° C.) are applied, so that the first color resist layer and the second color resist layer are slightly cured. In a process for manufacturing the third color resist layer, the third temperature with higher temperature is applied, and as a result, the first color resist layer, the second color resist layer and the third color resist layer are completely cured. However, since it is only need to apply the higher third temperature in a process for forming the third color resist layer, the lower temperature is only applied in a process for forming the first color resist layer and the second color resist layer, and therefore causes a reduction of energy dissipation as well as reduces production costs.

The above objectives, other objectives, features, advantages and embodiments of the present invention will be better understood from the following description being considered in connection with the accompanied drawings and in which a preferred embodiment of the invention is illustrated by way of example.

### BRIEF DESCRIPTION OF THE DRAWINGS

FIG. 1 is a flow chart of a method according to a preferred embodiment of the present invention for manufacturing a color filter; and

FIGS. 2A to 2E are schematic views of a structure of a manufacturing process for the color filter according to the present invention.

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” “left,” “right,” “inside,” “outside,” “side,” etc., is used with reference to the orientation of the Figure(s) being described. As such, the directional terminology is used for purposes of illustration and is in no way limiting. Throughout this specification and in the drawings like parts will be referred to by the same reference numerals.

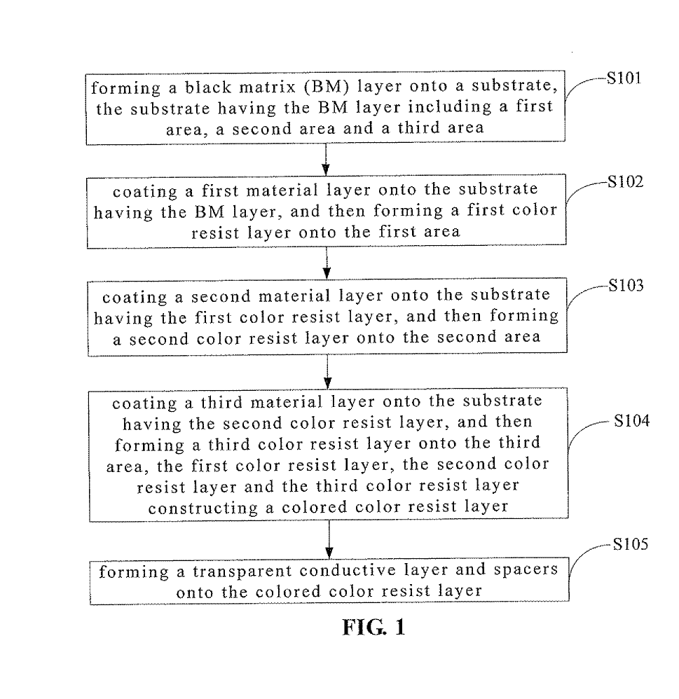

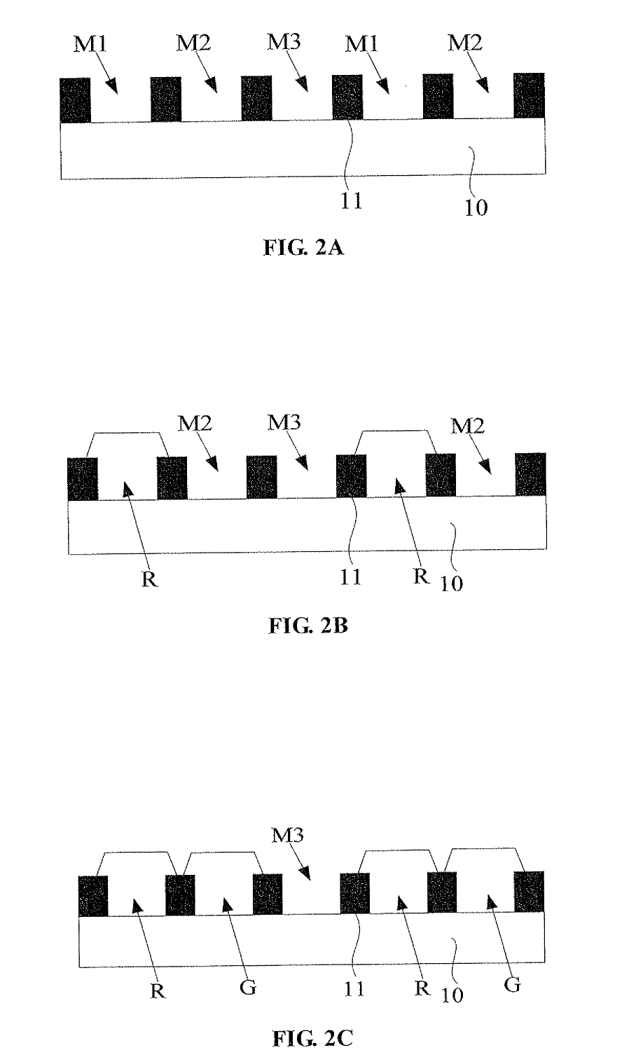

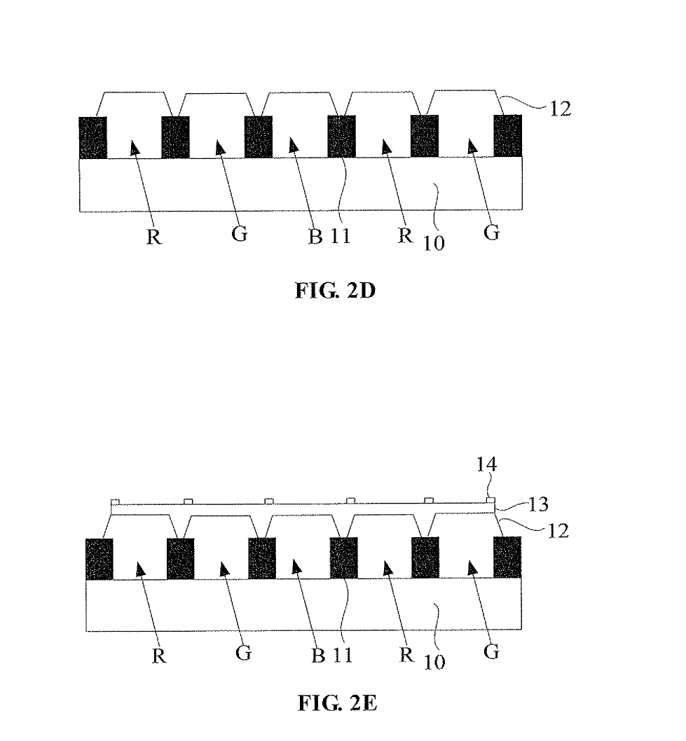

FIG. 1 is a flow chart of a method according to a preferred embodiment of the present invention for manufacturing a color filter, and FIGS. 2A to 2E are schematic views of a structure of a manufacturing process for the color filter.

In step S101, provided is the substrate 10, and a black matrix (BM) layer 11 is formed on the substrate 10. The substrate 10 having the BM layer 11 includes a first area M1, a second area M2 and a third area M3.

Please also refer to FIG. 2A. The substrate 10 is first cleaned to remove small foreign matters and particles on the substrate 10. Then, the substrate 10 is dried to remove water for cleaning the substrate 10. Then, the substrate 10 is blew by ion wind to eliminate static electricity on the substrate 10, and then a UV light is irradiated on the substrate 10 to decompose and remove organic matters on the substrate 10. Then, the substrate 10 is pre-cured to dry the residual water on the substrate 10, and then the substrate 10 is cooled to 23° C. for further use.

Then, a black material layer is coated on the substrate 10, and the substrate 10 having the black material layer is dried under decompression, so as to uniform dry the coated black material layer as well as avoid a bubbling occurrence. Then, the substrate 10 having the black material layer is heated to dry the water thereof, and then the substrate 10 having the black material layer is cooled to 23° C.

Then, the substrate 10 having the black material layer is exposed and developed to form BM layer 11. Preferably, a mask used in an exposing process is quartz glass. An object of a developing process is for removing the black material layer (i.e., a photoresist material) of non-exposure area, and the black material layer of exposure area is remained to form BM layer 11. Then, the substrate 10 having the BM layer 11 is cleaned to remove a residual solvent (e.g., a developing solution), and then the substrate 10 having the BM layer 11 is dried to remove water.

Final, the BM layer 11 on the substrate 10 is cured, for example, the substrate 10 having the BM layer 11 is cured for some time (e.g., 1800 seconds) at 230° C. to completely cure the BM layer 11 on the substrate 10. Final, the substrate 10 having the BM layer is cooled.

In step S102, a first material layer is coated on the substrate 10 having the BM layer 11, and then a first color resist layer R is formed on the first area M1 of the substrate 10 having the BM layer 11 by the exposing process, the developing process and a curing process in sequence.

Please also refer to FIG. 2B. A UV light is first irradiated on the substrate 10 having the BM layer 11 which is processed by step S101, so as to remove organic matters on the substrate 10 having the BM layer 11. Then, the substrate 10 having the BM layer 11 is cleaned and dried to remove residual particles. Then, the substrate 10 having the BM layer 11 is blew by ion wind to eliminate static electricity. Then, the substrate 10 having the BM layer 11 is pre-cured to dry the water thereof, and then it is cooled to 23° C. for further use.

Then, the first material layer is coated on the substrate 10 having the BM layer 11, and then the substrate 10 having the first material layer is dried under decompression, so as to uniform dry the first material layer as well as avoid a bubbling occurrence. Then, the substrate 10 having the first material layer is heated to dry the water thereof, and then it is cooled to 23° C.

Then, the substrate 10 having the first material layer is exposed and developed to form the first color resist layer Ron the first area M1 of the substrate 10 having the BM layer 11. Preferably, the mask used in the exposing process is quartz glass. An object of the developing process is for removing the first material layer (i.e., the photoresist material) of non-exposure area, and the first material layer of exposure area is remained to form the first color resist layer R. Then, the substrate 10 having the first color resist layer R is cleaned to remove the residual solvent (e.g., the developing solution), and then the substrate 10 having the first color resist layer R is dried to remove water.

Final, the substrate 10 having the first color resist layer R is cured. The cure is performed at a first temperature T1, the first temperature T1 preferably is between 150° C. and 200° C. After curing the substrate 10 having the first color resist layer R by the first temperature T1, the first color resist layer R is slightly cured. The slight cure means that the first color resist layer R remain fixed in basic shape thereof for a first preset time, and an under cut occurrence cannot occur. The first preset time being a time lasting until curing the third color resist layer B.

In the process of the specific embodiment, the slight cure of the first color resist layer R is achieved by cooperating an exposure energy, a developing time and a curing time of the first temperature T1 in a process of curing the first color resist layer R by the first temperature T1, and will not be discussed here.

In step S103, a second material layer is coated on the substrate 10 having the first color resist layer R, and then a second color resist layer G is formed on the second area M2 of the substrate 10 having the BM layer 11 by the exposing process, the developing process and a curing process in sequence.

Please also refer to FIG. 2C. The UV light is first irradiated on the substrate 10 having the first color resist layer R which is processed by step S102, so as to remove organic matters on the substrate 10 having the first color resist layer R. Then, the substrate 10 having the first color resist layer R is cleaned and dried to remove residual particles. Then, the substrate 10 having the first color resist layer R is blew by ion wind to eliminate static electricity. Then, the substrate 10 having the first color resist layer R is pre-cured to dry the water thereof, and then it is cooled to 23° C. for further use.

Then, the second material layer is coated on the substrate 10 having the first color resist layer R, and then the substrate 10 having the second material layer is dried under decompression, so as to uniform dry the second material layer as well as avoid the bubbling occurrence. Then, the substrate 10 having the second material layer is heated to dry the water thereof, and then it is cooled to 23° C.

Then, the substrate 10 having the second material layer is exposed and developed to form the second color resist layer G on the second area M2 of the substrate 10 having the BM layer 11. Preferably, the mask used in the exposing process is quartz glass. An object of the developing process is for removing the second material layer (i.e., the photoresist material) of non-exposure area, and the second material layer of exposure area is remained to form the second color resist layer G Then, the substrate 10 having the second color resist layer G is cleaned to remove the residual solvent (e.g., the developing solution), and then the substrate 10 having the second color resist layer G is dried to remove water.

Final, the substrate 10 having the second color resist layer G is cured. The cure is performed at a second temperature T2, the second temperature T2 preferably is between 150° C. and 200° C. (e.g., 200° C.). After curing the substrate 10 having the second color resist layer G by the second temperature T1, the second color resist layer G is slightly cured. The slight cure means that the second color resist layer R remain fixed in basic shape thereof for a second preset time, and an under cut occurrence cannot occur. The second preset time being a time lasting until curing the third color resist layer B.

In the present embodiment, the first color resist layer R cannot react with a solvent used in a process for forming the second color resist layer G in the slight cure. The solvent includes a solvent for the second material layer and the developing solution used in a process for forming the second color resist layer G, and the like.

Moreover, the first color resist layer R has light resistance in the slight cure, that is, when the second material layer is exposed, the first color resist layer R cannot change in light irradiation for the exposing process.

In a process of curing the second color resist layer G by the second temperature T2, the slight cure of the second color resist layer G is achieved by cooperating the exposure energy, the developing time and a curing time of the second temperature T2, and will not be discussed here.

In step S104, a third material layer is coated on the substrate 10 having the second color resist layer G, and then the third color resist layer B is formed on the third area M3 of the substrate 10 having the BM layer 11 by the exposing process, the developing process and a curing process in sequence. The first color resist layer R, the second color resist layer G and the third color resist layer B construct a colored color resist layer 12.

Please also refer to FIG. 2D. The UV light is first irradiated on the substrate 10 having the second color resist layer G which is processed by step S 103, so as to remove organic matters on the substrate 10 having the second color resist layer G. Then, the substrate 10 having the second color resist layer G is cleaned and dried to remove residual particles. Then, the substrate 10 having the second color resist layer G is blew by ion wind to eliminate static electricity. Then, the substrate 10 having the second color resist layer G is pre-cured to dry the water thereof, and then it is cooled to 23° C. for further use.

Then, the third material layer is coated on the substrate 10 having the second color resist layer G. Then, the substrate 10 having the third material layer is dried under decompression, so as to uniform dry the formed third material layer as well as avoid a bubbling occurrence. Then, the substrate 10 having the third material layer is heated to dry the water thereof, and then it is cooled to 23° C.

Then, the substrate 10 having the third material layer is exposed and developed to form the third color resist layer B on the third area M3 of the substrate 10 having the BM layer 11. Preferably, the mask used in the exposing process is quartz glass. An object of the developing process is for removing the third material layer (i.e., the photoresist material) of non-exposure area, and the third material layer of exposure area is remained to form the third color resist layer B. Then, the substrate 10 having the third color resist layer B is cleaned to remove the residual solvent (e.g., the developing solution), and then the substrate 10 having the third color resist layer B is dried to remove water.

Final, the substrate 10 having the third color resist layer B is cured. The cure is performed at a third temperature T3, the third temperature T3 is more than the first temperature T1 and the second temperature T2, the third temperature T3 preferably is between 220° C. and 240° C. (e.g., 230° C.). After curing the substrate 10 having the third color resist layer B by the third temperature T3, the first color resist layer R, the second color resist layer G and the third color resist layer B are completely cured to form the colored color resist layer 12. The complete cure is a further cure based on the slight cure. In a state of the complete cure, in addition to remain fixed in basic shape, the first color resist layer R, the second color resist layer G and the third color resist layer B further increase a hardness thereof.

In the process of the specific embodiment, a crosslinking degree of surfaces of the first color resist layer R and the second color resist layer G must be in accordance with chemical resistance of step S104 in a curing process of the first temperature T1 and the second temperature T2, that is, the first color resist layer R and the second color resist layer G cannot react with a solvent used in a process for forming the third color resist layer B in the slight cure. The solvent includes a solvent for the third material layer and the developing solution used in a process for forming the third color resist layer B, and the like.

Moreover, in the curing process of the first temperature T1 and the second temperature T2, photoresist molecules within the first color resist layer R and the second color resist layer G have not achieve a complete cross-link. However, after performance of the curing process at the third temperature T3, the photoresist molecules within the first color resist layer R and the second color resist layer G are completely crosslinked, and photoresist molecules within the third color resist layer B are also completely crosslinked.

Moreover, the first color resist layer R and the second color resist layer G have light resistance in the slight cure, that is, when the third material layer is exposed, the first color resist layer R and the second color resist layer G cannot change in light irradiation for the exposing process.

In step S105, a transparent conductive layer 13 and spacers 14 are formed on the colored color resist layer 12 (please also refer to FIG. 2F).

In a process for forming the first color resist layer and the second color resist layer according to the present invention, the first temperature and the second temperature that have a lower temperature than that of the third temperature (230° C.) are applied, so that the first color resist layer and the second color resist layer are slightly cured. In a process for manufacturing the third color resist layer, the third temperature with higher temperature is applied, and as a result, the first color resist layer, the second color resist layer and the third color resist layer are completely cured. However, since it is only need to apply the higher third temperature in a process for forming the third color resist layer, the lower temperature is only applied in a process for forming the first color resist layer and the second color resist layer, and therefore causes a reduction of energy dissipation as well as reduces production costs.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a color filter, the method comprising steps of:
providing a substrate, and forming a black matrix (BM) layer onto the substrate, the substrate having the BM layer comprising a first area, a second area and a third area;
coating a first material layer onto the substrate having the BM layer; and then forming a first color resist layer onto the first area by an exposing process, a developing process and a curing process in sequence, the curing process being performed at a first temperature, after performance of the curing process at the first temperature, the first color resist layer being slightly cured;
coating a second material layer onto the substrate having the first color resist layer, and then forming a second color resist layer onto the second area by the exposing process, the developing process and the curing process in sequence, the curing process being performed at a second temperature, after performance of the curing process at the second temperature, the second color resist layer being slightly cured;
coating a third material layer onto the substrate having the second color resist layer, and then forming a third color resist layer onto the third area by the exposing process, the developing process and the curing process in sequence, the curing process being performed at a third temperature; when the first color resist layer, the second color resist layer and the third color resist layer being cured by the third temperature, a complete cure of the first color resist layer, the second color resist layer and the third color resist layer being achieved by cooperating a curing time of the third temperature, wherein the third temperature is between 220° C. and 240° C.; the first color resist layer, the second color resist layer and the third color resist layer constructing a colored color resist layer; and
foaming a transparent conductive layer and spacers onto the colored color resist layer, wherein the first temperature and the second temperature are less than the third temperature; in the slight cure, shapes of the first color resist layer and the second color resist layer remain fixed for a preset time; in the complete cure, shapes of the first color resist layer, the second color resist layer and the third color resist layer continuously remain fixed.

2. The method for manufacturing a color filter of claim 1, wherein the first temperature is between 150° C. and 200° C.

3. The method for manufacturing a color filter of claim 1, wherein the second temperature is between 150° C. and 200° C.

4. The method for manufacturing a color filter of claim 1, wherein in a process of curing the first color resist layer by the first temperature, the slight cure of the first color resist layer is achieved by cooperating an exposure energy, a developing time, and a curing time of the first temperature.

5. The method for manufacturing a color filter of claim 1, wherein in a process of curing the second color resist layer by the second temperature, the slight cure of the second color resist layer is achieved by cooperating an exposure energy, a developing time, and a curing time of the second temperature.

6. The method for manufacturing a color filter of claim 1, wherein the first color resist layer does not react with a solvent used in a process for forming the second color resist layer in the slight cure; and
the solvent used in a process for forming the second color resist layer comprises a solvent for the second material layer and a developing solution used in a process for forming the second color resist layer.

7. The method for manufacturing a color filter of claim 1, wherein the first color resist layer and the second color resist layer does not react with a solvent used in a process for forming the third color resist layer in the slight cure; and
the solvent used in a process for forming the third color resist layer comprises a solvent for the third material layer and a developing solution used in a process for forming the third color resist layer.

8. The method for manufacturing a color filter of claim 1, wherein the shapes of the first color resist layer and the second color resist layer remain fixed for the preset time that specifically comprises:
a shape of the first color resist layer remaining fixed for a first preset time, the first preset time being a time lasting until curing the third color resist layer; and
a shape of the second color resist layer remaining fixed for a second preset time, the second preset time being a time lasting until curing the third color resist layer.

9. A method for manufacturing a color filter, the method comprising steps of providing a substrate, and forming a black matrix (BM) layer onto the substrate, the substrate having the BM layer comprising a first area, a second area and a third area;
coating a first material layer onto the substrate having the BM layer; and then forming a first color resist layer onto the first area by an exposing process, a developing process and a curing process in sequence, the curing process being performed at a first temperature, after performance of the curing process at the first temperature, the first color resist layer being slightly cured;
coating a second material layer onto the substrate having the first color resist layer, and then forming a second color resist layer onto the second area by the exposing process, the developing process and the curing process in sequence, the curing process being performed at a second temperature, after performance of the curing process at the second temperature, the second color resist layer being slightly cured;
coating a third material layer onto the substrate having the second color resist layer, and then forming a third color resist layer onto the third area by the exposing process, the developing process and the curing process in sequence, the curing process being performed at a third temperature, after performance of the curing process at the third temperature, the first color resist layer, the second color resist layer and the third color resist layer being completely cured; the first color resist layer, the second color resist layer and the third color resist layer constructing a colored color resist layer; and
forming a transparent conductive layer and spacers onto the colored color resist layer, wherein the first temperature and the second temperature are less than the third temperature; in the slight cure, shapes of the first color resist layer and the second color resist layer remain fixed for a preset time; in the complete cure, shapes of the first color resist layer, the second color resist layer and the third color resist layer continuously remain fixed.

10. The method for manufacturing a color filter of claim 9, wherein the first temperature is between 150° C. and 200° C.

11. The method for manufacturing a color filter of claim 9, wherein the second temperature is between 150° C. and 200° C.

12. The method for manufacturing a color filter of claim 9, wherein the third temperature is between 220° C. and 240° C.

13. The method for manufacturing a color filter of claim 9, wherein in a process of curing the first color resist layer by the first temperature, the slight cure of the first color resist layer is achieved by cooperating an exposure energy, a developing time, and a curing time of the first temperature.

14. The method for manufacturing a color filter of claim 9, wherein in a process of curing the second color resist layer by the second temperature, the slight cure of the second color resist layer is achieved by cooperating an exposure energy, a developing time, and a curing time of the second temperature.

15. The method for manufacturing a color filter of claim 9, wherein in a process of curing the first color resist layer, the second color resist layer and the third color resist layer by the third temperature, the complete cure of the first color resist layer, the second color resist layer and the third color resist layer is achieved by cooperating a curing time of the third temperature.

16. The method for manufacturing a color filter of claim 9, wherein the first color resist layer does not react with a solvent used in a process for forming the second color resist layer in the slight cure; and
the solvent used in a process for forming the second color resist layer comprises a solvent for the second material layer and a developing solution used in a process for forming the second color resist layer.

17. The method for manufacturing a color filter of claim 9, wherein the first color resist layer and the second color resist layer does not react with a solvent used in a process for forming the third color resist layer in the slight cure; and
the solvent used in a process for forming the third color resist layer comprises a solvent for the third material layer and a developing solution used in a process for forming the third color resist layer.

18. The method for manufacturing a color filter of claim 9, wherein the shapes of the first color resist layer and the second color resist layer remain fixed for the preset time that specifically comprises:
a shape of the first color resist layer remaining fixed for a first preset time, the first preset time being a time lasting until curing the third color resist layer; and
a shape of the second color resist layer remaining fixed for a second preset time, the second preset time being a time lasting until curing the third color resist layer.
